(19) United States
(12) Patent Application Publication
(10) Pub. No.: US 2026/0318279 A1
(43) Pub. Date: Oct. 15, 2026

(54) A SPAR FOR A WIND TURBINE BLADE

(71) Applicant: Structeam Ltd, Cowes Hampshire (GB)

(72) Inventors: Thomas COWAN, Cowes Hampshire (GB); Frédéric LOUARN, Cowes Hampshire (GB); Julien SELLIER, Cowes Hampshire (GB)

(21) Appl. No.: 19/482,129

(22) PCT Filed: May 7, 2024
(86) PCT No.: PCT/GB2024/051185

§ 371 Date: Nov. 6, 2025

(30) Foreign Application Priority Data
May 9, 2023 (GB) 2306812.5

(51) Int. Cl. F03D 1/06

(52) U.S. Cl. CPC F03D 1/0681; F03D 1/0677; F05B 2280/10304; F05B 2280/6003

(57) ABSTRACT

A spar (5) for a wind turbine blade (1) having a shear web (10) with a spar cap (11) at each end. The spar caps (11) are formed of a stack of planks (12A, B) with offset termination faces (20). A connector (16) extends across a termination face (20) with a first surface of the connector being attached to two planks of the spar cap. The connector (16) may have an opposite face with a different geometry. This may be connected to transfer the load from the spar cap (5) to an adjacent component or between adjacent planks.

The present invention relates to a spar for a wind turbine blade.

Wind turbine blades are formed of an aerodynamic shell forming the shape of the wind turbine blade. This is supported by an elongate spar which runs lengthwise along the blade and extends between the suction and pressure sides of the blade to provide the primary load carrying structure for the blade.

There is demand for wind turbine blades of increasing length in order to increase the output of each wind turbine such that blades of over 100 metres are now being contemplated. The blades are highly stiffness critical such that high performance composite materials such as carbon fibre reinforced plastic are being considered for the construction of spar caps. These have a very high specific stiffness which is typically three or four times that of glass fibre reinforced plastic. However, carbon fibre reinforced plastic is expensive and in short supply. As such, carbon fibres are only used in parts of the spar cap in selected regions which require enhanced stiffness. Such a spar cap is disclosed, for example, in US 2020/0300216.

In order to accommodate different materials within a spar cap, there are transitions along the spar cap between two material sections. One way to achieve this is to use a double scarf type joint as disclosed in WO 2012/004571. In this design, a spar cap is tapered in a depth wise dimension as it approaches an interface with an adjacent spar section. A shallow wedge shape connector is placed on the top of the spar cap in this tapering region and is adhered into place on top of the tapered sections. Alternatively, the connection piece may be formed in situ, by being built up from a number of layers.

A development of this idea is disclosed in EP 3098440 in which the shape and/or material of the connection piece varies along its length in order to be compatible with the materials of the components being connected.

The tapered regions of the spar caps potentially extend over a significant portion of the length of the spar. This is done in order to provide a large surface area for the bonding interface to reduce the localised stresses. In order to create the tapered areas, the spar cap is made with a uniform thickness. The tapered area is then machined, for example by grinding to form the tapered shape. As just the thickness of a plank is machined to create the taper, this results in significant material wastage and generates significant volumes of dust which can be harmful to operators, mechanical equipment and electrical systems which come into contact with the dust. This is particularly the case with a carbon fibre spar cap.

The present invention aims to provide an improved spar for a wind turbine blade.

According to the first aspect of the present invention, there is provided a spar according to claim 1.

Because the terminating faces are formed on the individual planks, rather than on the spar cap as a whole, for example, as in WO 2012/004571, the machining time is significantly reduced as is the wasted material and the dust generation. The invention is more flexible than the prior art as the technique can be applied in various scenarios and can be tuned to meet the needs of various interfaces.

The technique may be used to connect the spar cap to an adjacent component where only a first termination face is part of the connection and the second adjacent plank may then extend beyond the connection, for example to the end of the spar.

However, preferably, there are a plurality of layers with termination faces longitudinally offset from one another, and the connector extends across the plurality of termination faces. This is suitable, for example, for a connection between adjacent spar cap sections.

In this case, the lengthwise spacing between termination faces of adjacent planks is spread out to spread the shear loads significantly in the lengthwise dimension. The actual spacing may vary depending on the materials used, the number and size of the planks being terminated. The spacing can be unevenly spread across multiple planks. Preferably, however, the lengthwise spacing between termination faces of adjacent planks is at least as long as the average thickness of the adjacent planks.

Preferably, the plank closest to the shear web terminates furthest from the adjacent component and the plank furthest from the shear web terminates closest to the adjacent component. This is the geometrical opposite of the structure shown in WO 2012/004571 and EP 3098440 in which the taper is in the opposite sense.

In order to accommodate the connector, the shear web may be of uniform depth throughout. However, preferably the depth of the shear web is decreased in the vicinity of the adjacent component to accommodate an increased depth of the connector. This allows greater design freedom to design the geometry of the connector as it is not constrained by having to fit with a straight upper face of the shear web. This allows the connector to have a relatively thick central portion which assists in managing the transfer of the loads across the connector.

The first termination face may be an abrupt termination such that the termination face is in a plane perpendicular to the lengthwise dimension. However, preferably the termination face of the spar cap is tapered. The taper can be achieved by reducing thickness from one of the plank faces (forming a flat wedge shape) or from both plank faces (forming an arrowhead shape). However, the rate of thickness reduction in the lengthwise direction of the termination face may not be uniform. This helps to spread the transfer of the shear loads to the connector in the lengthwise dimension by reducing any abrupt transitions. Additional termination faces may terminate in the same way.

Preferably the lengthwise dimension of the taper is 3 to 10 times the thickness of the plank. This provides good load distribution without being so long that the amount of material wasted and the dust generation becomes unacceptable.

As a further means of avoiding abrupt transitions, preferably a first face of the connector is attached to the stack of planks and the opposite face has a non-linear configuration, wherein points of inflection in the second face are spaced in the lengthwise direction from the termination faces of the planks. This geometry minimises any stress concentrations within the joint.

Planks are understood in the art to be components with a significant thickness and stiffness. As such, layers of tape or fabric are not considered to be planks. However, the adjacent component to which the connector is attached may have a spar cap which is made as a layup of tapes or fabrics. The planks are generally precured or partially cured components. If the planks comprise glass fibres, they are preferably greater than 1.5 mm thick, while if the planks comprise carbon fibres, they are preferably greater than 1.0 mm thick.

The planks may be formed as prepregs. These will need to be made thicker than a standard prepreg. The planks are preferably pultrusions as these reduce the layup time. The pultrusion process allows a plurality of uniaxial fibres typically in a thermoset or thermoplastic resin arranged in the lengthwise dimension to be formed such that pultruded planks are ideal for stacking together to form the spar cap.

The spar cap is preferably bounded by inner and outer skins and the connector is accommodated between the inner and outer skins. This allows the whole spar cap including the connector to be made as a sub assembly which is defined within the skins.

The shape of the shear web may be moulded or machined to precisely match the shape of the adjacent face of the connector. This will allow a uniform layer of adhesive between the two components. However, preferably, the shape of the shear web does not match the shape of the adjacent face of the connector thereby forming a gap of varying depth which is filled with adhesive. This provides greater flexibility in designing the shape of the connector which can be optimised for load transfer. The shear web can then be adapted to accommodate this.

The connector may be formed of a composite material which may be built up from layers in a similar manner to the spar cap. However, preferably, the connector is metal, preferably a titanium alloy. This provides the necessary stiffness and fatigue strength. The connector may be formed as a stack of laminates, may be a moulded component, or may be made using additive manufacturing techniques, but is preferably a machined component.

The spar cap may comprise glass fibres, but preferably comprises carbon fibres. As set out previously, this is particularly useful for certain segments where optimum performance is required.

The spar cap section may be connected to another component such as a root or tip end. However, preferably, the adjacent component is a second spar cap section, and the connector is connected to transfer load from the spar cap to the second spar cap.

The spar cap and second spar cap may be formed of the same materials. However, the spar cap and second spar cap may be formed of different materials, as this can be accommodated by the connector. Alternatively, or additionally, the spar cap and second spar cap may have the same depth. However, the spar cap and second spar cap may have different depths, as this can be accommodated by the connector.

The present invention also extends to a method of making a spar cap for a wind turbine according to claim 19.

A technique similar to that described above may be used when the spar cap steps down by one plank. At present, this is done by tapering the plank over a long distance to spread the distance over which the load is transferred into the remaining planks.

According to a further aspect of the present invention, there is provided a spar according to claim 20. With such an arrangement, the termination face of the plank can be much shorter as the connector spreads the load longitudinally. This reduces the amount of machining required on the terminated face of the plank which reduces waste and dust as described above.

A number of prior art documents show spar caps formed of a stack of planks which terminate at tapered ends. In GB2601126 these are covered by an outer skin layer. WO2022/129130 has a glass biaxial layer to insulate exposed carbon fibre in the stack. EP3726049 has a current injection contact layer.

None of these layers is a structural connector. In each case the layer is provided for non-structural reasons. None of the layers is able to spread the load transfer from the first plank to the second plank along its length. The layers have a uniform thickness and extend across multiple planks.

Preferably the thickness of the structural connector varies along its length. This allows design freedom so that the connector can be sized to optimise the load transfer between planks.

The thickness of the structural connector is preferably greatest adjacent to the first termination face. The structural connector preferably tapers such that its thickness reduces towards each longitudinal end. This optimises the size of the connector at the point of greatest load transfer.

Preferably the structural connector is covered by a skin layer.

Preferably the structural connector terminates short of the second termination face. This allows the connector to be optimised to transfer the load just between the first and second planks.

An example of the spar cap and method of making a spar cap will now be described with reference to the accompanying drawings, in which:

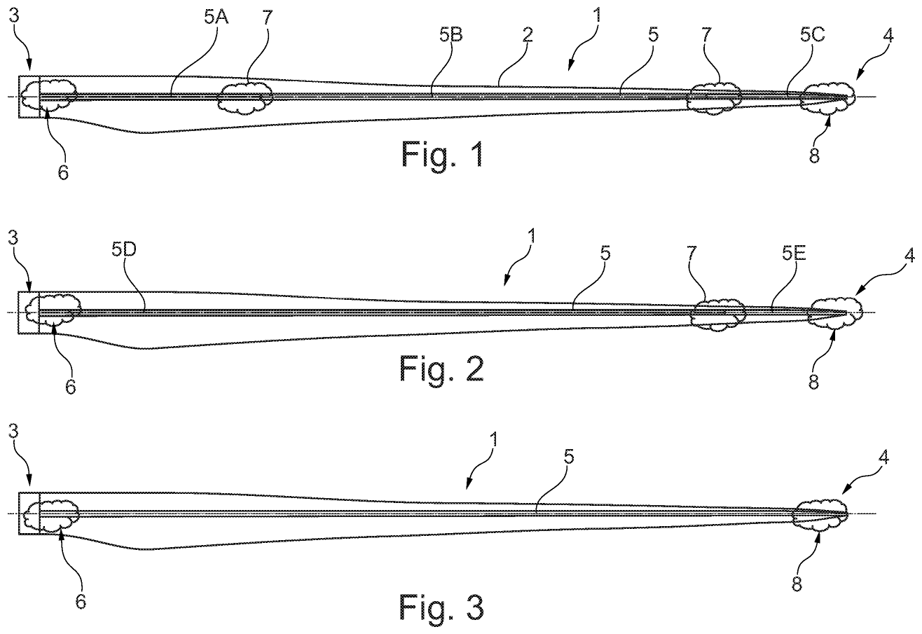

FIG. 1 is a schematic plan view of a first blade;

FIG. 2 is a schematic plan view of a second blade;

FIG. 3 is a schematic plan view of a third blade;

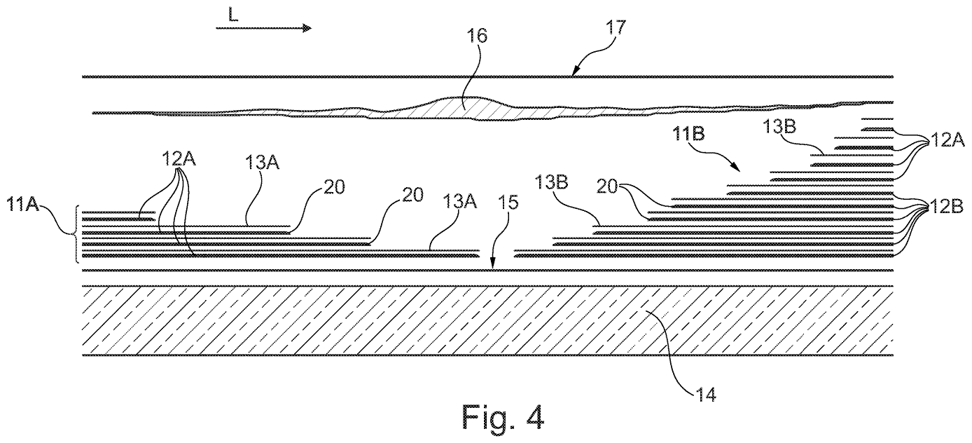

FIG. 4 is an exploded cross-section of a mould and various layers of the spar cap prior to assembly;

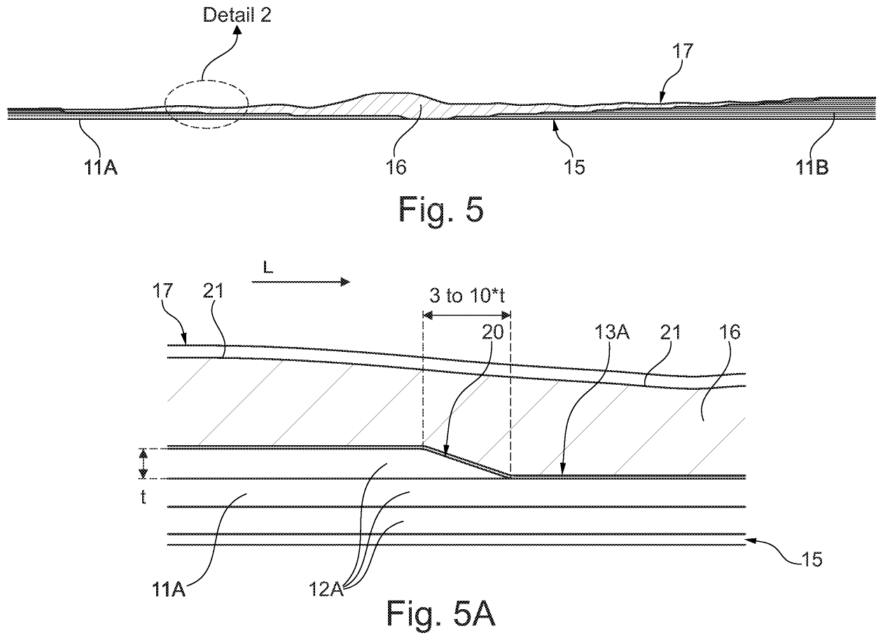

FIG. 5 shows the spar cap formed from the layers of FIG. 4;

FIG. 5A is a cross-section showing the detail in the area in ring A in FIG. 5;

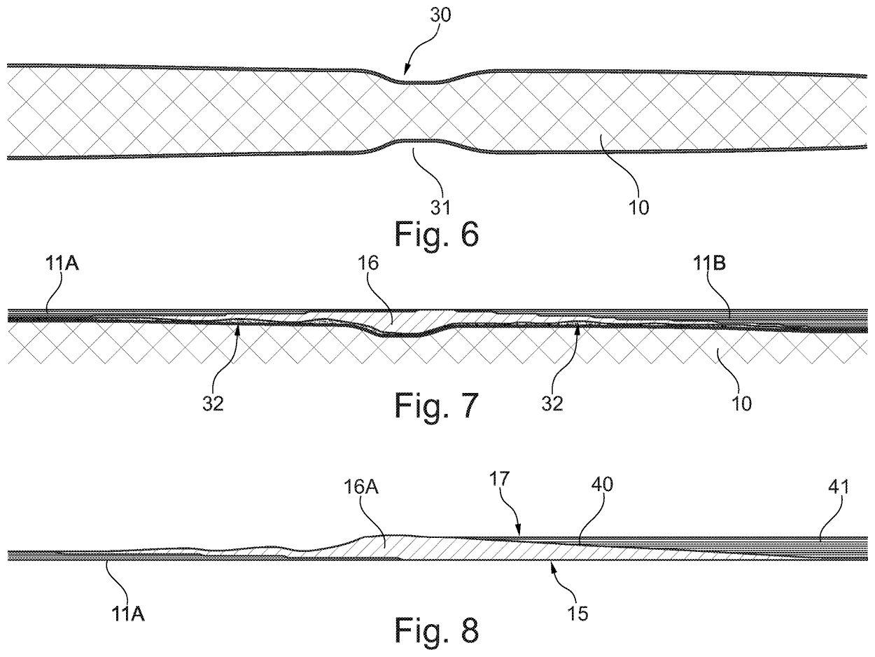

FIG. 6 is a side view of the shear web;

FIG. 7 is a section showing a spar cap of FIG. 5 (illustrated the opposite way up) assembled on the shear web of FIG. 6;

FIG. 8 is a cross section of an alternative spar cap;

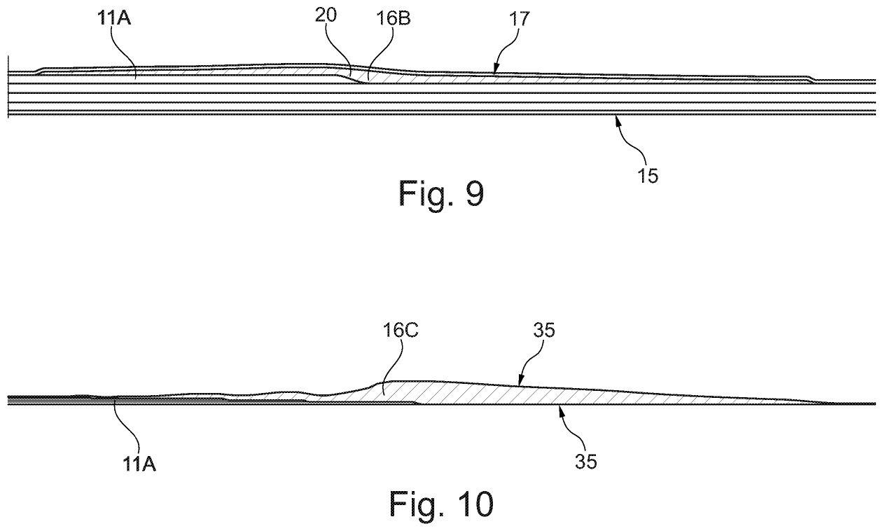

FIG. 9 is a cross-section showing a connector with a single plank of the spar cap being terminated in accordance with the second aspect of the invention;

FIG. 10 is a cross section of a connector at the tip end;

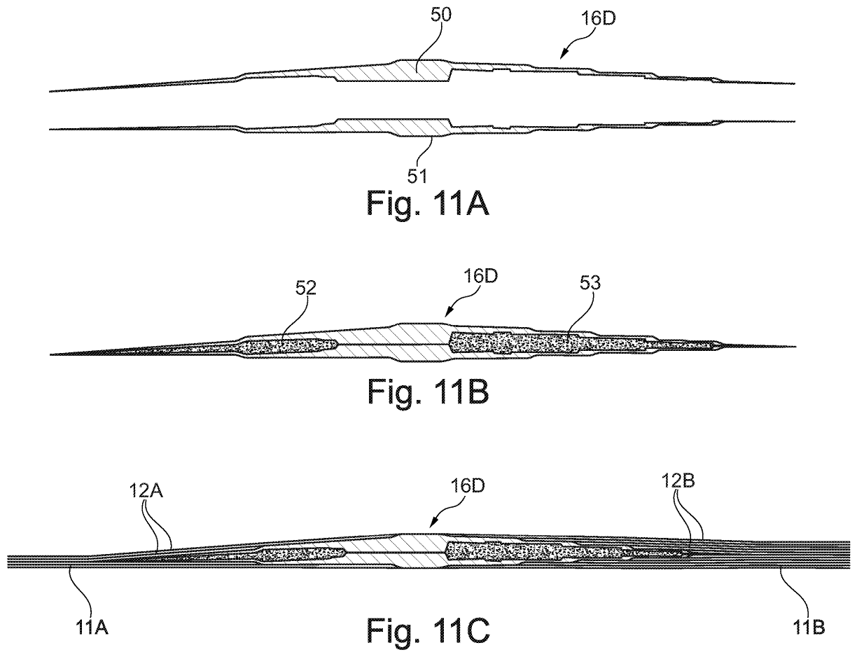

FIGS. 11A to 11C are cross-sections showing an alternative design of connector at various stages of manufacture.

As shown in FIGS. 1 to 3, a wind turbine blade 1 is formed of an aerodynamic fairing 2 extending from a root 3 to a tip 4. A spar 5 extends from the root 3 to the tip 4 to provide the primary load carrying structure of the blade. The spar 5 has a beam-like structure and can be an I-beam formed of a single shear web 10 with a spar cap 11 at either end. Alternatively, the beam is preferably a box beam with two or more shear webs or a C beam.

In FIG. 1, the spar cap 11 is divided into three sections, 5A, 5B, 5C. Inner spar cap section 5A is formed of a uniaxial fibre reinforced plastic and has a joint 6 attaching the spar cap 5 to the root end and a joint 7 at the opposite end connecting the spar cap section 5A to the central spar cap section 5B. The central spar cap section 5B is formed of a uniaxial fibre reinforced plastic and has a joint 7 at its outermost end for connection to the third spar cap section 5C which leads to the tip end joint 8 which is the same as the joint 6. The fibres may be different in the various sections as required. For example, some sections have glass fibres and others have carbon fibres or other suitable materials.

The two joints 7 in FIG. 1 between adjacent spar cap sections are essentially the same as one another, but in reverse. The number of planks being joined may vary from joint to joint.

As an alternative, in FIG. 2, the spar 5 is formed of an inner spar cap section 5D and an outer spar cap section 5E. The joint 7 between the two connections is effectively the same as the innermost joint 7 in FIG. 1. The joint 6 at the spar cap root end will be effectively the same as the joint for the spar cap root end 6 in FIG. 1. The tip end joint 8 is also the same as for FIG. 1.

FIG. 3 shows the spar 5 formed as a single component. In this case, the only joints are the spar cap root end joint 6 and tip end joint 8.

The details of the structure and manufacture of a spar cap will now be described with reference to FIGS. 4 to 7.

FIGS. 5 and 7 show the joint between a first spar cap section 11A and a second spar cap section 11B. This joint is suitable for joints 7 shown in FIGS. 1 and 2.

Each of the spar caps 11A and 11B are formed of a plurality of planks 12A, 12B formed as pultrusions which are alternated with interface layers 13A and 13B which promote resin flow through the structure. In this particular example, in the spar cap 11A, there are four planks whereas in the spar cap 11B, there are ten planks. The number of planks can be varied in other examples depending on the loads in the spar cap. The spar cap 11A is formed of a high performance material such as carbon fibre reinforced plastic, while the spar cap 11B is formed of a material such as a glass fibre reinforced plastic. The connection that has to be made at this point is between two spar caps of different materials and different thicknesses.

In order to begin the manufacturing process, the pultrusions 12A and 12B and interface layers 13A and 13B are laid into a mould 14 on top of a lower skin 15 as shown in FIG. 4. These layers could alternatively be laid up in the blade fairing. The connector 16 (described in greater detail below) is put in place between the spar caps 11A, 11B before the stack is covered with the upper skin 17 and the assembly is subject to an infusion and curing process. The connector 16 may be provided with through holes to allow resin to flow down through the connector. At this stage, other components such as copper mesh for lightning protection can be incorporated into the structure.

As is apparent from the Figures, each of planks 12A, 12B terminates at a location which is significantly spaced in the longitudinal direction L from an adjacent plank. This forms a stepped lap joint. Further, each of the planks 12A, 12B has a tapered end 20. The tapered end is shown in detail in FIG. 5A.

The tapered end 20 is formed by cutting the end of the plank 12, for example using water jet cutting or laser cutting, such that the length of the taper is between 3 and 10 times the thickness of the plank.

FIG. 5A also shows the shape of the connector 16. As can be seen in FIG. 5A, the connector 16 has a number of points of inflection spaced in the lengthwise dimension L from the tapered end 20. As a result, the change in geometry of the inner face of the connector 16 in the vicinity of the tapered end 20 is significantly longer and more gradual than the tapered end 20. As a result of the geometry of the tapered end 20 and the inner surface of the connector 16, the loads applied from the terminating plank 12 into the connector 16 are spread lengthwise and the gradual change of geometry of the upper face also helps to reduce the stress concentrations in this transition. The inner surface variations are driven by the need to optimize the stiffness ratio between the connector and the spar cap. The fact that the tapered ends 20 of adjacent planks are significantly spread in the lengthwise dimension L further reduces the stress concentrations between the ends of each of the adjacent planks 12.

As a result of all of the geometrical considerations, including the need to connect between two spar caps 11A, 11B having a significant number of planks and the need for the geometry of the upper face of the connector 16 to vary as set out above to reduce stress concentrations at the tapered ends, the inner face of the connector 16 has a highly irregular shape. Further, towards the centre of the connector 16, more planks 12A, 12B are terminated such that the connector naturally has a shape which is thicker in the middle and tapers towards both ends. The finished shape of the connected spar caps is shown in FIG. 5.

FIG. 7 shows how the spar cap assembly is attached to the shear web 10. The shear web 10 is a continuous component which extends across the junction between the spar caps 11A, 11B. Alternatively it may be in separate sections which have a junction adjacent to the connector 16 or elsewhere. As shown in FIG. 6, the shear web 10 has upper and lower recesses 30, 31. The recess shapes have approximately the same profile as the corresponding spar cap assembly. Although not apparent from the drawings, the shear web 10 is much thinner in a dimension perpendicular to the plane of the paper than the spar cap assemblies. The gap between the upper and lower faces of the shear web 10 and the spar caps 11A, 11B is filled with an adhesive 32. As will be apparent from FIG. 7, the profile of the upper face of the shear web 10 does not exactly match the profile of the connector 16 such that the gap filled by the adhesive 32 has a variable depth.

As a result of this variable gap and the recesses 30, 31 in the shear web 10, there is significant design freedom in the manufacture of the connector 16. Thus, the geometry of the connector 16 can be selected based primarily on the requirements of the load transfer between the spar caps 11A, 11B.

An alternative spar cap configuration is shown in FIG. 8. In this case, the left-hand side of the spar cap has a similar construction to the left-hand side of the spar cap of the first example. However, on the right-hand side, the connector 16 has a constant taper 40 which connects to a spar cap 41 which is formed as an infused structure, rather than being formed of pultruded planks. As such, the interface between the connector 16 and the spar cap 41 is a simple constant taper. This allows a connection to be made between a pultruded spar cap 11A and an infused spar cap stack 41.

FIG. 9 shows an arrangement in which a single plank is terminated. This may happen along the length of the blade as the load requirements reduce towards the blade tip. In this case, the connector 16B has a geometry with only a single taper on its lower surface corresponding to the taper 20 of the terminated plank. The connector 16B is adhered to the terminated plank and to the adjacent plank.

FIG. 10 shows an arrangement suitable for the joint 6 at the root end 3. The left-hand end of the connector 16C provides an interface with the spar cap 11A as previously described in order to terminate the spar cap 11A. The righthand end of the connector 16C has a gently tapered wedge shape (similar to that shown in FIG. 7) which connects to the root laminate 35. A similar joint may be applied as the tip end joint 8. The loads are transferred from the tapering spar cap 11A to the connector 16C, then, from the connector 16C to the root or tip skins along the connector taper.

In the above examples, the connector 16 has been formed as a solid component preferably formed of a metal such as a titanium alloy. An alternative method of construction of the connector 16D is shown in FIGS. 11A and 11C. In this case, the connector is formed in two parts 50 and 51, which may be laminated structures, mouldings, additively manufactured or machined components. The two components are then joined creating two internal voids 52, 53 which may be hollow, or filled with a filler such as a foaming epoxy providing a shear connection across the pockets.

As shown in FIG. 11C, the connector 16D is configured such that the planks 12A, 12B can terminate on both sides of the connector 16D.

1. A spar for a wind turbine blade;
the spar extending lengthwise and having a shear web with a spar cap at each end;
wherein at least one of the spar caps is formed of a stack of planks;
wherein a first plank terminates at a first termination face, while a second adjacent plank continues lengthwise past the first termination face and terminates at a second termination face longitudinally spaced from the first termination face, and
a connector extending across the first termination face with a first surface of the connector facing and being attached to the first and second planks of the spar cap, and a second surface opposite to the first surface and having a geometry different to the first surface and being connected to an adjacent component to transfer the load from the spar cap to the adjacent component.

2. A spar according to claim 1, wherein there are a plurality of planks with termination faces longitudinally offset from one another, and the connector extends across the plurality of termination faces.

3. A spar according to claim 2, wherein the lengthwise spacing between termination faces of adjacent planks is at least as long as the average thickness of the adjacent planks.

4. A spar according to claim 1, wherein the plank closest to the shear web terminates furthest from the adjacent component and the plank furthest from the shear web terminates closest to the adjacent component.

5. A spar according to claim 1, wherein the depth of the shear web is decreased in the vicinity of the adjacent component to accommodate an increased depth of the connector.

6. A spar according to claim 1, wherein the termination face of the plank is tapered.

7. A spar according to claim 6, wherein the lengthwise dimension of the taper is 3 to 10 times the thickness of the plank.

8. A spar according to claim 1, wherein a first face of the connector is attached to the stack of planks, and the opposite face has a non-linear configuration, wherein points of inflection in the opposite face are spaced in the lengthwise direction from the termination faces of the planks.

9. A spar according to claim 1, wherein the planks are pultrusions.

10. A spar according to claim 1, wherein the spar cap is bounded by inner and outer skins and the connector is accommodated between the inner and outer skins.

11. A spar according to claim 1, wherein the shape of the shear web does not match the shape of the adjacent face of the connector, thereby forming a gap of varying depth which is filled with adhesive.

12. A spar according to claim 1, wherein the connector is metal.

13. A spar according to claim 12, wherein the connector metal is a titanium alloy.

14. A spar according to claim 1, wherein the connector is a machined component.

15. A spar according to claim 1, wherein the spar cap comprises carbon fibres.

16. A spar according to claim 1, wherein the adjacent component is a second spar cap section and the connector is connected to transfer load from the spar cap to the second spar cap.

17. A spar according to claim 16, wherein the spar cap and the second spar cap are formed of different materials.

18. A spar according to claim 16, wherein the spar cap and the second spar cap have different thickness.

19. A method of making a spar for a wind turbine blade, according to claim 1, the method comprising the steps of;
forming a plurality of planks for the spar cap, the planks terminating at different lengthwise locations;
attaching the planks together to form the spar cap; and
attaching the spar cap to the shear web with the connector in the space between the spar cap and shear web.

20. A spar for a wind turbine blade;
the spar extending lengthwise and having a shear web with a spar cap at each end;
wherein at least one of the spar caps is formed of a stack of planks;
wherein a first plank terminates at a first termination face, while a second adjacent plank continues lengthwise past the first termination face and terminates at a second termination face longitudinally spaced from the first termination face, and
a structural connector extending across the first termination face with a first surface of the connector facing and being attached to the first and second planks of the spar cap either side of the first termination face to spread the load transfer from the first plank to the second plank along the length of the connector.

21. A spar according to claim 20, wherein the thickness of the structural connector varies along its length.

22. A spar according to claim 21, wherein the thickness of the structural connector is greatest adjacent to the first termination face.

23. A spar according to claim 21, wherein the structural connector tapers such that its thickness reduces towards each longitudinal end.

24. A spar according to claim 20, wherein the structural connector is covered by a skin layer.

25. A spar according to claim 20, wherein the structural connector terminates short of the second termination face.
